(19) United States
(12) Patent Application Publication
(10) Pub. No.: US 2008/0306706 A1
(43) Pub. Date: Dec. 11, 2008

(54) Accelerometer System

(76) Inventor: Nenad Markovic, Land O' Lakes, FL (US)

Correspondence Address: GERARD CARLSON, 4503 S. RIVA RIDGE WAY, BOISE, ID, 83709, US

(21) Appl. No.: 11/934,178

(22) Filed: Nov. 2, 2007

Related U.S. Application Data
(60) Provisional application No. 60/933,537, filed on Jun. 7, 2007.

(51) Int. Cl. G06F 15/00; G01P 15/00

(52) U.S. Cl. 702/141

(57) ABSTRACT

An accelerometer system comprises an accelerometer, a processor or threshold system connected to the accelerometer to receive electronic signals from accelerometer indicating acceleration and an annunciator connected to the processor or threshold system to receive electronic signals indicating the magnitude of acceleration. The annunciator produces a human discernable signal to notify of acceleration levels. The accelerometer system alerts vehicle operators of acceleration levels. The accelerometer system may be used to train vehicle operators to drive in a manner that reduces excessive acceleration. One embodiment prolongs battery life by turning off components in between measurements based on acceleration activity. Another embodiment packages the accelerometer system to fit into a cigarette lighter plug for vehicle use.

### CROSS REFERENCE TO RELATED APPLICATIONS

This application claims the benefit of the U.S. provisional application Ser. No. 60/933,537 filed Jun. 6, 2007 entitled “Apparatus and Method to Train Drivers to Drive in a Fuel Efficient Manner” by Nenad Markovic.

### FEDERALLY SPONSORED RESEARCH OR DEVELOPMENT

Not applicable.

### JOINT RESEARCH AGREEMENT

Not applicable

### SEQUENCE LISTING

Not applicable

### FIELD OF THE INVENTION

The present invention relates to the field of accelerometer systems, and in particular to devices that communicate acceleration levels to a vehicle operator.

### BACKGROUND OF THE INVENTION

Internal combustion engines which drive motor vehicles such as automobiles and trucks are relatively inefficient and consume large quantities of hydrocarbon based fuels. It is well known in the field that the efficiency of fuel consumption for vehicles powered by internal combustion engines is related to the manner in which an operator operates such vehicles.

Thus, operators of vehicles powered by internal combustion engines can decrease fuel consumption by more gradual acceleration and braking. Furthermore, there are additional benefits to encouraging controlled acceleration and braking. Deterring “jack rabbit” stop and go driving and overly aggressive acceleration trains operators of vehicle to become inherently safer drivers. Also, abrupt acceleration and braking places unneeded stress on parts within vehicles such as tires, brake pads, and even the engine itself.

Acceleration in the forward or rearward directions of a vehicle is not the only source of mechanical wear and tear. Lateral acceleration, from side to side, caused by aggressive turning can also wear vehicle components such as tires, suspension and steering.

### SUMMARY OF THE INVENTION

In one embodiment, an accelerometer system uses an accelerometer, a microprocessor connected to the accelerometer to receive electronic signals from the accelerometer indicating acceleration, and an annunciator connected to the microprocessor to receive electronic signals from the microprocessor indicating the magnitude of acceleration. The annunciator produces a human recognizable signal that indicates the magnitude of the acceleration.

In another embodiment, an accelerometer system uses an accelerometer, a timer, a threshold system, and an annunciator. The threshold system, activated by the timer, compares accelerometer values with a threshold value. If the accelerometer values exceed the threshold, the threshold system activates the annunciator to indicate the magnitude of acceleration.

In yet another embodiment, a method for operating an accelerometer system energizes the accelerometer while making an acceleration measurement and turns off the accelerometer in between measurements. The time interval between measurements is adjusted based on acceleration activity. This adaptive method extends battery life in battery operated accelerometer systems.

### BRIEF DESCRIPTION OF THE DRAWINGS

The summary above, and the following detailed description will be better understood in view of the enclosed drawings which depict details of various embodiments. It should however be noted that the invention is not limited to the precise arrangement shown in the drawings and that the drawings are provided merely as examples.

FIG. 1 is a block diagram of one embodiment of an accelerometer system.

FIG. 2 is a block diagram of one embodiment of a processor system.

FIG. 3 is a block diagram of an alternate embodiment of an accelerometer system.

FIG. 4 is a front perspective view of one embodiment of an accelerometer system enclosure.

FIG. 5 is a front perspective view of an alternate embodiment of an accelerometer system enclosure.

FIG. 6 is a timing diagram of two pulse rates.

FIG. 7 is a flow diagram of an exemplary method to operate an accelerometer system.

FIG. 8 is a schematic diagram of one embodiment of an accelerometer system.

### DETAILED DESCRIPTION

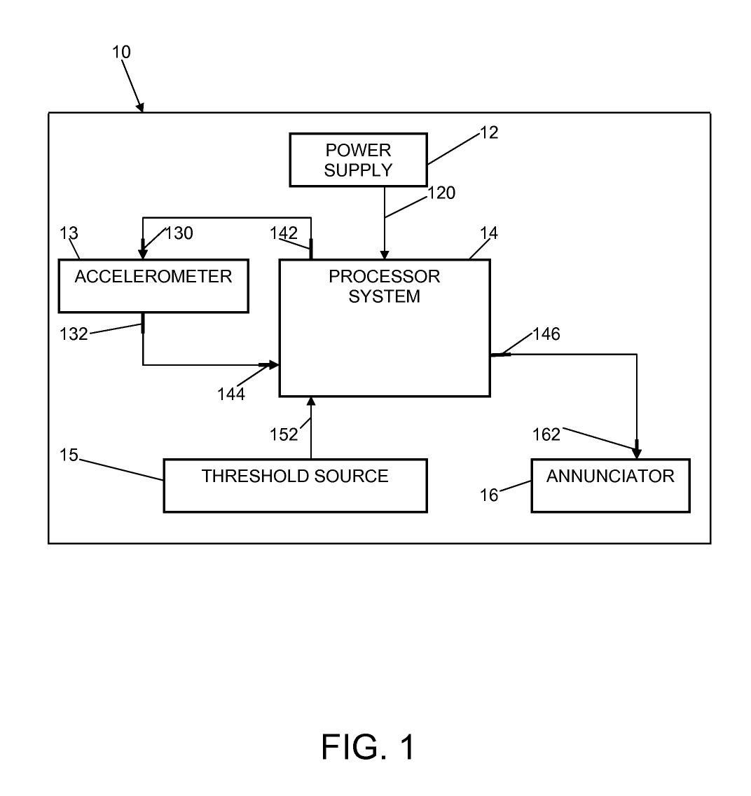

In the accelerometer system 10, of FIG. 1, a power supply 12, powers a processor system 14 via a power connection 120. The processor system 14 controls a power output 142 to energize the accelerometer 13 via an accelerometer power input 130. The accelerometer output 132, of the accelerometer 13 connects to the accelerometer input 144 of the processor system 14. An annunciator 16 has an annunciator input 162 which is controlled by the threshold comparator output 146 of the processor system 14. The processor system 14 receives a threshold value 152 from a threshold source 15.

In operation, the processor system 14 turns on the accelerometer 13 via the power output 142 and accelerometer power input 130. The accelerometer 13 generates an electrical value which corresponds to the acceleration experienced by the accelerometer 13. This value, encoded as a voltage in some embodiments, is available at the accelerometer output 132. The processor system 14 receives a value from the accelerometer output 132 on the accelerometer input 144 and compares it with a threshold value 152 received from the threshold source 15. If the threshold value 152 is exceeded by the value at the accelerometer input 144, the processor system 14 activates the threshold comparator output 146. When active, the threshold comparator output 146, connected to the annunciator input 162, activates the annunciator 16. The annunciator 16 interfaces with a human through one of the human senses.

In this application, the term acceleration can mean either an increase of speed or a decrease of speed. The embodiments in this application can be configured to indicate an increase of speed, typically called acceleration in automotive circles, or a decrease of speed due to braking. Depending upon application, the various embodiments can indicate an increase in speed, a decrease in speed or both.

Each of the components of FIG. 1 has many possible embodiments. In one embodiment the accelerometer 13 is an integrated circuit with the accelerator output 132 being an analog voltage output responsive to the acceleration experienced by the accelerometer 13. One example of an integrated circuit accelerometer is the ADXL322 by Analog Devices of Norwood, Mass. Other accelerometers may provide serial or parallel digital outputs with the accelerometer output 132 being serial or parallel bus. Still other accelerometers may provide multiple outputs responsive to acceleration in more than one dimension. An example is an accelerometer with accelerometer outputs for three orthogonal axis typically labeled X, Y and Z.

In one embodiment, the accelerometer power input 130 of the accelerometer 13 is the power supply of the accelerometer integrated circuit. The power output 142 of the processor system 14 enables the processor system 14 to turn the accelerometer 13 on (energize) and off. While the power output 142 is shown in FIG. 1 as a simple connection to the accelerometer power input 130, it can also include a power amplifier or switch in cases where the power output 142 is unable to provide adequate current or voltage to the accelerometer power input 130. In such cases, the power output controls a switch (not shown) that switches power from the power supply 12 turning the accelerometer 13 on and off.

The accelerometer input 144 of the processor system 14 receives the accelerometer output 132. The type of accelerometer output 132 determines the type of accelerometer input 144. For example, if the accelerometer output 132 is an analog signal, the accelerometer input 144 can be an analog to digital converter input or a comparator input to the processor system 14. If conversely, the accelerometer output 132 is a digital signal, the accelerometer input 144 is a digital input, serial or parallel, with enough individual signal wires to receive the accelerometer output 132. If the accelerometer output 132 communicates acceleration information for multiple dimensions, the accelerometer input 144 is chosen to compatibly receive the acceleration values.

The power supply 12 of FIG. 1 can take many forms. In one embodiment, power supply 12 is a common 9 volt battery with a voltage regulator or regulators and filtering to supply the correct voltage or voltages to the accelerometer 13, the processor system 14 and the annunciator 16. In other embodiments the power supply is a regulator and filter system that connects to a vehicle battery either directly or via a plug such as a cigarette lighter.

The threshold source 15 can take many forms. In the simplest form the threshold value 152 is encoded into the processor system 14 program. In this case, it is a fixed value or set of fixed values. In other embodiments, the threshold source 15 provides a user adjustable threshold value 152. Such a user adjustable threshold value 152 enables a user to determine the acceleration level at which the processor system 14 activates the annunciator 16. In practice, the threshold source can take the form of a potentiometer providing an analog input or a switch system providing a digital input. Depending upon the embodiment, threshold source 152 can represent a single value or a set of threshold values. The processor system 14 uses a set of multiple threshold values 152 to activate multiple threshold comparator outputs 146. Multiple threshold comparator outputs 146 activate various responses from the annunciator 16.

The annunciator 16 is interface between the processor system 14 and a human user (not shown). The annunciator can take many forms depending upon the embodiment. The main types are: light, sound, voice, vibration and smell. Thus the term annunciator, as used in this application means one or a combination of the types listed above. Each of these types has several variations and exemplary embodiments are given in the following paragraphs.

In one embodiment, the processor system 14 uses three threshold values corresponding to mild, moderate and harsh acceleration. Consequently, the annunciator 16, has three levels of enunciation to indicate the levels of mild, moderate, and harsh acceleration. The threshold comparator output 146 and annunciator input 162 also have an encoding to activate the annunciator 16 accordingly. The encoding to indicate multiple threshold values 146 can be any number of systems, including, but not limited to, parallel signal lines, pulse width modulation, frequency modulation, a command structure on a serial or parallel bus or others. Those skilled in the art can devise a system to implement the threshold comparator output 146 and annunciator input 162 for the various types described below.

An LED or light emitting diode is a simple example when light is used for the annunciator 16. Multiple forms of light output are possible. Examples include a single LED that changes in intensity or flashing frequency as successive threshold values are reached. Other examples include a system of LEDs that light up progressively or change color, for example, from green to yellow to red. One multi-LED embodiment lights a green LED when the driver is in an optimal range of acceleration. An optimal acceleration range results in a smooth, gentle acceleration and less fuel consumption. Accelerating too quickly results in more fuel consumption, with first the yellow and then the red LEDs illuminating.

A sound based annunciator can use a speaker, beeper, or buzzer to notify a human of acceleration levels. When multiple levels of acceleration are indicated, the sound can be modulated by frequency, amplitude or duration.

The annunciator can use spoken notifications or warnings as various levels of acceleration are reached. These spoken warnings are recorded voice outputs that can be permanently recorded or recordable by the user. When multiple threshold values are used, the voice can vary in volume, tone or urgency with spoken messages such as; “Easy.”, “Slowly!” or “Back Off”. Integrated circuit voice record/playback devices are known to those skilled in the art. One example is the ISD1740 series by Winbond Electronics Corporation America of San Jose, Calif.

A vibration annunciator can vibrate a vehicle control such as the steering or accelerator pedal to notify the operator of acceleration levels.

As an example of aversion therapy, an olfactory (smell) based annunciator can emit disagreeable odors to notify and discourage the operator from excessive acceleration.

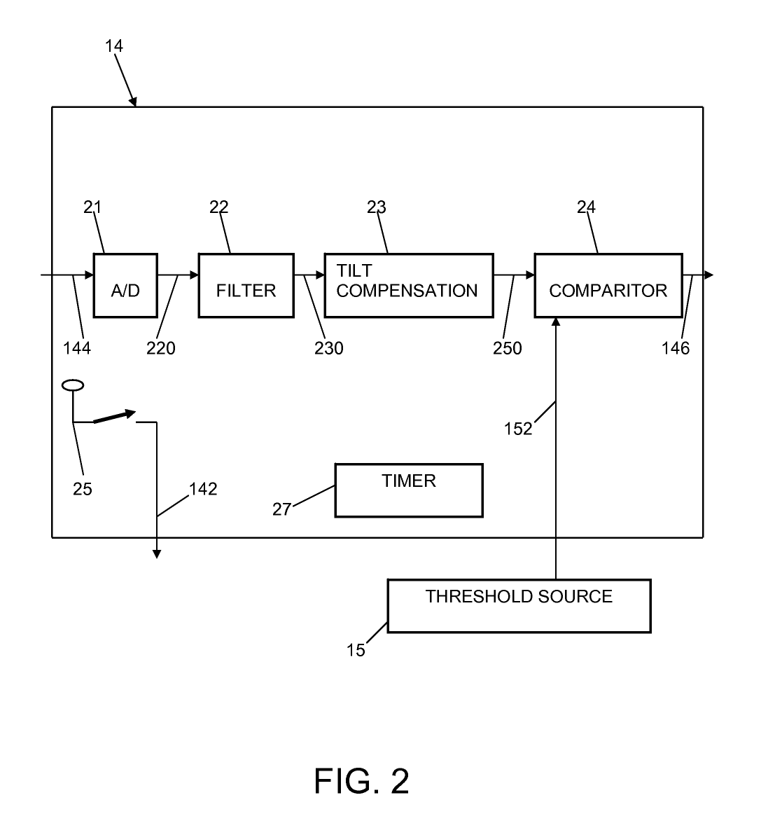

FIG. 2 shows an exemplary processor system 14. An embodiment using this processor system 14 has an analog accelerometer input 144 which connects to the accelerometer output 132 of FIG. 1. An A/D (analog to digital converter) 21 receives the voltage of the analog acceleration value at the accelerometer input 144 and converts it to a digital accelerometer value 220.

The filter 22 is any number of digital filter types such as a finite impulse response (FIR), infinite impulse response (IIR), or moving average filter (MA). Combinations and variations are possible such as a weighted moving average. One embodiment uses a moving average of eight samples in one to two seconds. The filter acts as a low pass filter to remove the brief acceleration spikes due to pot holes and uneven roadway. Such brief spikes do not usually indicate driver acceleration and are therefore filtered to reduce false annunciations. The filter output is a filtered accelerometer value 230. In other embodiments, an analog filter is placed ahead of the A/D. Thus either an analog or digital filter or a combination is possible. In some embodiments, a program of the processor system 14, implements the digital filter. In other embodiments, dedicated hardware implements the digital filter.

Referring to FIG. 1, when the accelerometer system 10 is placed in a vehicle, the system is placed so that the axis of the accelerometer 13 aligns with the desired dimension. For example, if indication of acceleration in a forward and rearward direction is desired, the accelerometer 13 is aligned along the front to rear axis of the vehicle. If lateral (side to side) indication is desired, the accelerometer 13 is aligned to measure side to side acceleration. If the accelerometer 13 is mounted or placed in a vehicle with a slight initial tilt, there will be an offset error due to gravity. That is to say, the accelerometer 13 will indicate acceleration even when the vehicle is not moving. Returning to FIG. 2, the tilt compensation 23 removes this error by subtracting or otherwise removing the effects of the tilt from the measured acceleration. This is accomplished in a number of ways. In a one embodiment, the accelerometer system 10 (FIG. 1) is first turned on when the vehicle is on a level surface. At power up, the tilt compensation stores the accelerometer reading when the vehicle is stopped on a level surface. This reading corresponds to tilt and is used to compensate subsequent accelerometer values. The tilt compensated output 250 more truly represents acceleration. In some embodiments, the tilt compensation 23 is implemented by a program of the processor system 14.

The comparator 24 inputs the tilt compensated output 250 for comparison with one or more threshold values 152. Threshold Source 15 provides the threshold values 152. Threshold source 15 may be a user adjustable input device or one or more values stored in the program of the processor system 14. If the acceleration represented by the values on the tilt compensated output 250 exceed one or more threshold values 152, the comparator 24 activates one or more corresponding threshold comparator outputs 146. In one embodiment, the threshold source provides three threshold values encoded into the program of the processor system 14. As the tilt compensated value 250 exceeds each of the threshold values 152, a corresponding threshold comparator output 146 activates the annunciator 16 (FIG. 1). In this example embodiment, the threshold comparator output 146 has three signal lines which each energize a distinct response of the annunciator 16. In some embodiments, the comparator 24 is implemented by a program of the processor system 14 and the threshold comparator output 146 is implemented by one or more general purpose outputs of the processor system 14.

The power output control 25 depicted by a simple switch in FIG. 2 represents an output of the processor system 14 which controls the power output 142. The power output 142 acts to provide power to the accelerometer 13 of FIG. 1. This implementation enables the program of the processor system 14 to turn on (energize) or turn off the power to the accelerometer 13 (FIG. 1). Turning the accelerometer power off in between acceleration measurements prolongs battery life in battery powered applications.

The timer 27 in one embodiment is a part of the processor system 14. The timer 27 under control of the program of the processor system 14 triggers operations such as that of the A/D 21, the filter 22, power output control 25, and the comparator 24. The program can also use the timer to control the duration of the threshold comparator output 146 and thus the duration of the annunciator output.

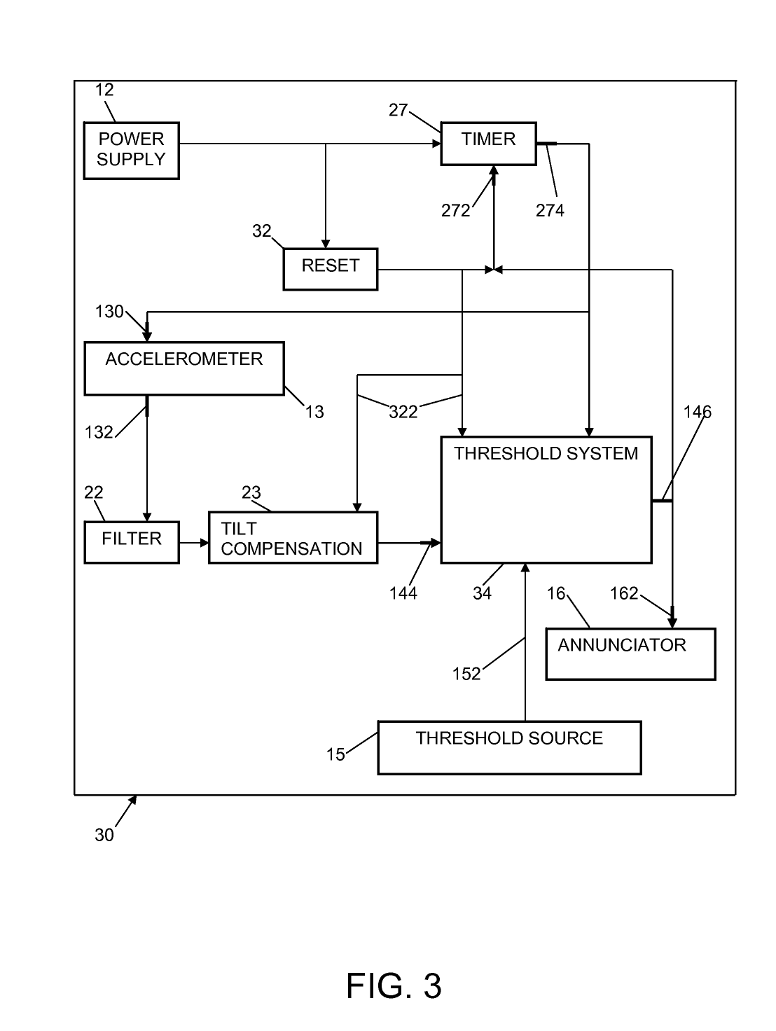

While FIGS. 1 and 2 showed a processor based accelerometer system, FIG. 3 shows an alternate embodiment of an accelerometer system 30. The accelerometer system 30 can be implemented with discrete analog or digital electronics. Other embodiments of accelerometer system 30 can be implemented with field programmable gate arrays (FPGAs) or custom integrated circuit technologies in either analog or digital methodologies.

The power supply 12, accelerometer 13, threshold source 15, annunciator 16, filter 22, and tilt compensation 23 perform similar functions as those in FIG. 1 or 2. The threshold system 34 is made of digital or analog comparators depending upon the technology or methodologies chosen. Power supply 12 provides power to the reset 32 and timer 27. The timer output 274 provides power to the threshold system 34 and to the accelerometer 13 via the accelerometer power input 130. The accelerometer output 132 provides a measurement of the acceleration value. The acceleration value at accelerometer output 132 can be further filtered or compensated by filter 22 and tilt compensation 23. The threshold system 34 receives the accelerometer value after filtering and compensation. Depending upon implementation, filtering and compensation is not always performed. The threshold source 15 connects to the threshold system providing the threshold value 152. The threshold comparator output 146 from the threshold system 34 connects to the annunciator input 162 of the annunciator 16. The threshold comparator output 146 also connects to the timer input 272 of timer 27.

In operation, the threshold system 34 receives an acceleration value at the accelerator input 144 and makes one or more comparisons against one or more threshold values 152. If a threshold value 152 is exceeded, the threshold system activates a corresponding threshold comparator output 146.

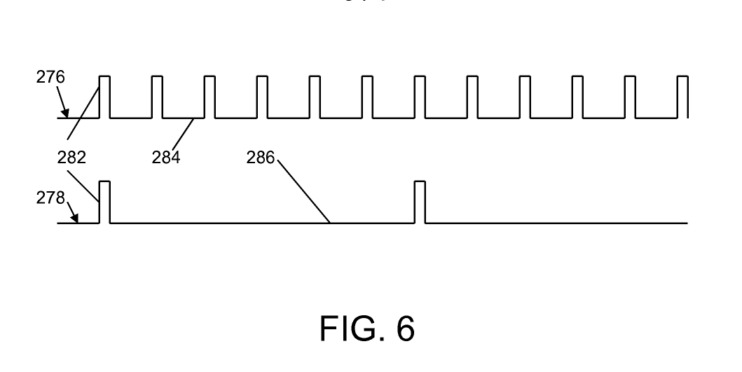

The timer 27 produces a pulse stream at the timer output 274. Referring to FIG. 6, the pulse stream takes one of two forms, a first faster pulse rate 276 or a second slower pulse rate 278. Both pulse rates 276 and 278 have an active portion 282. The first faster pulse rate 276 has shorter inactive period 284 while the second slower pulse rate 278 has a longer inactive period 286. Returning to FIG. 3, the timer 27, has a timer input 272 that controls whether the timer 27 produces the first faster pulse rate 276 (FIG. 6) or second slower pulse rate 278 (FIG. 6).

At power up or reset, the reset 32 initializes the tilt compensation 23, threshold system 34 and the timer 27 via the reset output 322. Upon reset, the timer output 274 outputs the first faster pulse rate 276 (FIG. 6). The active pulse 282 (FIG. 6) activates the accelerometer 13 to make a measurement and threshold system 34 to set the threshold comparator output 146 based on a comparison between the value at the accelerometer input 144 and a threshold value 152. When the timer output 274 outputs the longer inactive period 286 (FIG. 6) the accelerometer 13 and threshold system 34 go into a lower power state. This lower power state reduces power consumption and prolongs battery life in battery powered systems.

Threshold comparator output 146 also controls the timer input 272. If the threshold comparator output 146 remains inactive for a period of time, the timer input 272 directs the timer 27 to provide the second slower pulse rate 278 (FIG. 6) on timer output 274. The slower pulse rate has a longer inactive period 286 (FIG. 6) and reduces the power consumption of the accelerometer system 30. If the threshold system activates the threshold comparator output 146 due to a value at the accelerometer input 144 exceeding a threshold value 152, the timer input 272 directs the timer to output the first faster pulse rate 276 (FIG. 6). In this manner, the timer 27 activates the accelerometer system 30 components less frequently during periods of lesser acceleration activity and more frequently during periods of greater acceleration activity. This adaptive nature of the timer 27 prolongs battery life during less active periods of acceleration without sacrificing responsiveness during active periods.

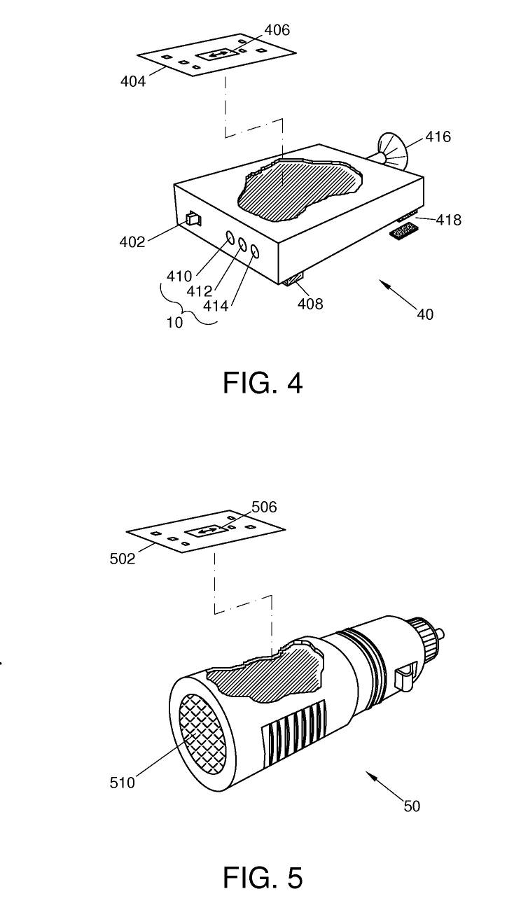

Many packaging alternatives are available for the accelerometer system 10 of FIG. 1 or accelerometer system 30 of FIG. 3. FIG. 4 shows a box enclosure 40 which contains a printed circuit assembly 404 (PCA) holding accelerometer system 10 (FIG. 1) or 30 (FIG. 3) components. In the embodiment depicted in FIG. 4, the annunciator 16 is made of three LEDs 410, 412, and 414. A switch 402, turns on and off the accelerometer system and also serves as a way to initiate a reset of the accelerometer system. The PCA 404 is oriented in the box enclosure 40 such that the when the LEDs 410, 412, and 414 face the rear of the vehicle, the accelerometer axis 406 is oriented to measure the forward or rearward acceleration of the vehicle.

Several mounting systems are available to mount the box enclosure 40 of FIG. 4 to a vehicle. Examples include simply sitting the box enclosure on the dash with small feet 408 or a pad to reduce sliding. Other methods include a suction cup 416 for attachment to the inside of the windshield. Other example methods include, but are not limited to adhesives and hook and latch fasteners 418.

FIG. 5 shows another embodiment of an accelerometer system enclosure. In FIG. 5, a cigarette lighter enclosure 50, is adapted to contain the accelerometer system PCA 502 and a speaker 510. The cigarette lighter enclosure 50 fits into the 12 volt power outlet or cigarette lighter location found in most vehicles. This embodiment enables the accelerometer system to use the vehicle power supply in place of dedicated batteries. When the cigarette lighter enclosure 50 plugs into the dash of a vehicle, the accelerometer axis 506, mounted to the printed circuit assembly 502, is oriented to measure acceleration along the desired dimension. In the embodiment of FIG. 5, the speaker 510 is part of an annunciator embodiment that uses sound or voice to alert the operator to acceleration.

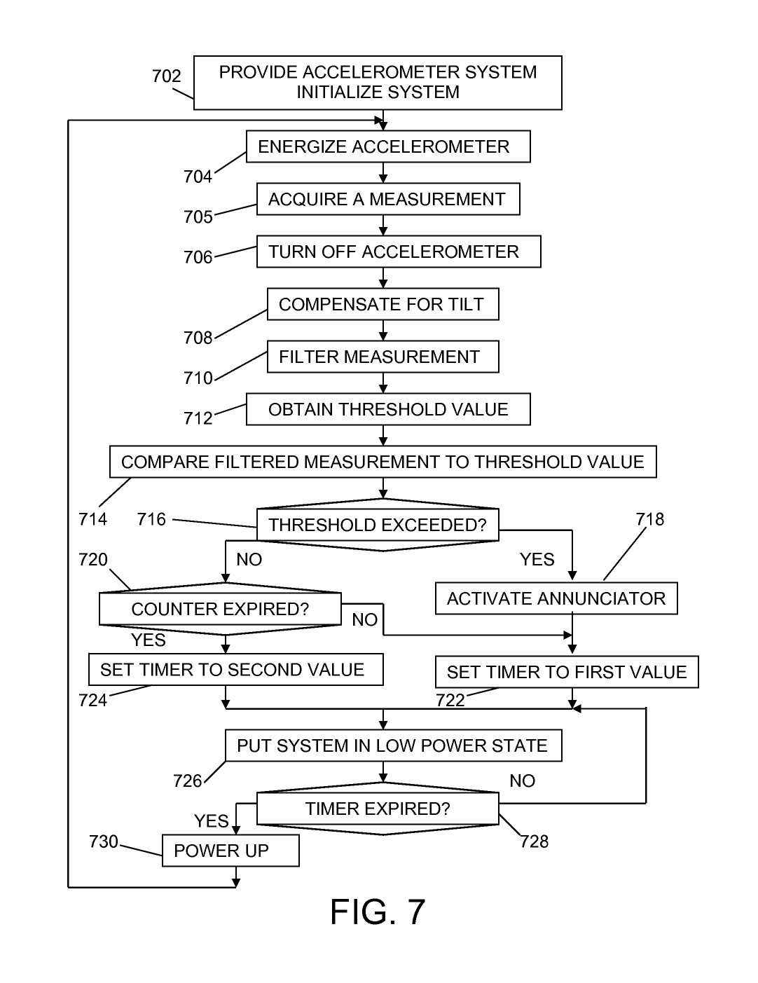

FIG. 7 is a flow chart of a method for operating the accelerometer system of FIG. 1 or 3. Although shown as a set of sequential steps, not all the steps are necessary to operate the accelerometer system, nor is it always necessary to perform the steps in the given order. The steps shown in FIG. 7 can be implemented as steps in a program of processor system 14 (FIGS. 1 and 2) or as parts of a more hardware implemented accelerometer system 30 (FIG. 3).

Step 702 provides and initializes an accelerometer system as described in previous paragraphs. Step 704 turns on or energizes the accelerometer in preparation for an acceleration measurement in 705. After a measurement is acquired, the accelerometer is turned off in 706 to prolong battery life. Step 708 compensates the measurement for tilt while step 710 filters out noise and 712 obtains one or more threshold values in preparation for comparison.

Steps 714 and 716 measure the acceleration value against one or more threshold values. If the acceleration value exceeds a threshold value, the system actives the annunciator at 718 and sets the timer to a first value at 722 corresponding to more frequent measurements.

If the acceleration value does not exceed a threshold value, the system sets the timer to a second value at 724 corresponding to less frequent measurements and therefore less energy consumption. A counter at 720 can be used to require a given number of passes before the timer is set to the second value. Counting out the number of passes that the measurement does not exceed a threshold value can be used to delay setting the timer to the second value. In some embodiments the timer or counter can be set to progressively longer times between measurements if there is no acceleration activity.

After the timer is set, the system goes into a low power state at 726. A low power state can be a sleep mode in a processor, or a power off state in a component such as an accelerometer, an annunciator or a threshold system. The timer controls the length of time that the system is in the low power state. Step 728 checks the timer condition. If the timer has not yet expired, the system remains in the low power state. If the timer expires, the system powers up at 730 and proceeds to make another measurement beginning at 704.

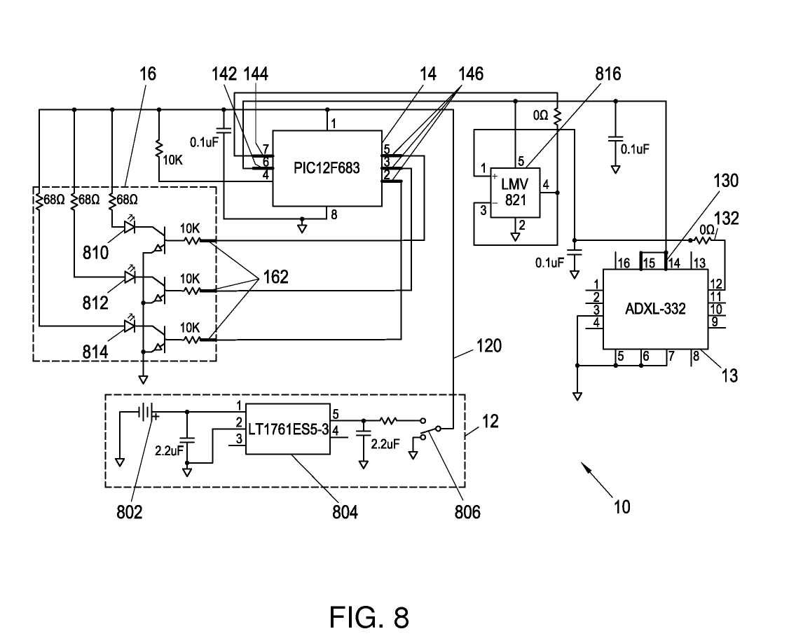

FIG. 8 is a schematic of an embodiment of the accelerometer system 10 (FIG. 1). The power supply 12 is made of a battery 802, a voltage regulator 804 and a switch 806. The battery 802 may be a dedicated battery or part of a vehicle electrical system. The power connection 120 from the power supply 12 connects to the processor system 14 and the annunciator 16. The accelerometer 13 provides an accelerometer output 132 which is buffered by an amplifier 816. The output of the amplifier connects to the accelerometer input 144 of the processor system 14. The processor system 14 has a power output 142 which provides power to the amplifier 816 and the accelerometer power input 130. Three outputs from the processor system make up the threshold comparator output 146. The threshold comparator output 146 connects to the annunciator input 162. In this embodiment three LEDs 810, 812, 814 and their transistor drivers make up the annunciator 16.

In operation, the battery 802 and voltage regulator 804 provide a suitable voltage for the other accelerometer system components. The processor system 14 initializes when the switch 806 of the power supply 12 turns on. During initialization, internal registers are set up, a value is established for tilt compensation and threshold values are established. The processor system 14 under program control then turns on the accelerometer 13, via the power output 142 and the accelerometer power input 130. The accelerometer input 144 of the processor system 14 receives the accelerometer output 132, buffered by amplifier 816. Internally the processor system 14, under program control, performs filtering, tilt compensation and comparison of the measured accelerometer value against three threshold values. The three comparisons determine the state of the three lines which make up the threshold comparator output 146. If a threshold is exceeded by the acceleration value, the program activates the corresponding signal of the threshold comparator output 146. The annunciator 16 illuminates an LED 810, 812, 814 if the corresponding signal in the annunciator input 162 is activated by a signal in the threshold comparator output 146. The processor program then sets an internal timer and/or counter based on acceleration activity, turns off the accelerometer 13 and goes into a low power sleep state until the timer expires. At timer expiration, the program again turns on the accelerometer 13 and repeats the process.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, which is defined in the following claims.

What is claimed is:

1. An accelerometer system comprising:
an accelerometer having a power input, and an accelerometer output;
an annunciator, the annunciator having the an annunciator input; and
a processor system, comprising an accelerometer input connected to the accelerometer output, a threshold comparator output connected to the annunciator input, a power output connected to the accelerometer power input.

2. The accelerometer system of claim 1 further comprising:
an threshold source to provide a threshold value to the processor system.

3. The accelerometer system of claim 1 further comprising:
a cigarette lighter enclosure.

4. The accelerometer system of claim 1 further comprising:
the annunciator having a recorded voice output.

5. A method for operating the accelerometer system of claim 1 comprising the steps of:
energizing the accelerometer by activating the power output;
acquiring a measurement from the accelerometer input;
comparing the measurement to a threshold value; and
activating the annunciator by activating the threshold comparator output if the measurement exceeds the threshold value.

6. The method of claim 5 further comprising the step of:
compensating for tilt.

7. The method of claim 5 further comprising the step of:
filtering the measurement.

8. An accelerometer system comprising:
a timer, the timer having a timer output with a first faster pulse rate, and a second slower pulse rate, the output pulse rate selectable by a timer input;
an accelerometer, activated by the timer output, the accelerometer having an accelerometer output responsive to the acceleration of the accelerometer;
a threshold system activated by the timer output, the threshold system connected to the accelerometer output, the threshold system having a threshold comparator output, the threshold comparator output active when the accelerometer output exceeds a threshold value, the threshold comparator output further operatively connected to the timer input to activate the first faster pulse rate when the threshold comparator output is active; and
an annunciator, activated by the threshold comparator output.

9. The accelerometer system of claim 8 further comprising:
a threshold source connected to the threshold system to provide the threshold value.

10. The accelerometer system of claim 8 further comprising:
a cigarette lighter enclosure.

11. The accelerometer system of claim 8 further comprising:
a mounting system to orient the accelerometer system along an axis of a motor vehicle.

12. The accelerometer system of claim 8 further comprising:
the annunciator having a recorded voice output

13. The accelerometer system of claim 8 further comprising:
a tilt compensation.

14. The accelerometer system of claim 8 further comprising:
a filter.

15. The accelerometer system of claim 8 further comprising:
a reset.

16. A method for indicating acceleration comprising the steps of:
(a) providing an processor system, the processor system comprising a timer, a threshold comparator output, a power output, and an accelerometer input;
(b) providing an accelerometer, the accelerometer having an accelerometer output connected to the processor system accelerometer input, the accelerometer further having a power input connected to processor system power output;
(c) providing an annunciator, the annunciator operatively connected to the threshold comparator output;
(d) initializing the processor system;
(e) initializing the timer;
(f) energizing the accelerometer;
(g) acquiring a measurement from the accelerometer output;
(h) turning off the accelerator;
(i) comparing the measurement with a threshold value;
(j) activating the annunciator if the measurement exceeds the threshold value;
(k) setting the timer to a first value if the measurement exceeds the threshold value;
(l) setting the timer to a second value if the measurement does not exceed the threshold value;
(m) putting the processor system into a low power consumption state until the timer expires;
(n) powering up the processor; and
(o) iterating steps (f) through (n) when the timer expires.

17. The method of claim 16 further comprising the step of:
filtering the measurement prior to the comparing step.

18. The method of claim 16 further comprising the step of:
compensating the measurement for tilt prior to the comparing step.

19. The method of claim 16 further comprising the step of:
obtaining a threshold value prior to the comparing step.

20. The method of claim 16 further comprising the step of:
counting out the passes that the measurement does not exceed the threshold before setting the timer to the second value.
